(19) United States
(12) Patent Application Publication
(10) Pub. No.: US 2003/0128933 A1
(43) Pub. Date: Jul. 10, 2003

(54) Light-coupling device

(75) Inventors: Gian-Luca Bona, Hedingen (CH); Wolfgang Denzel, Langnau am Albis (CH)

Correspondence Address: Peter M. Klett, Intellectual Property Law Dept., IBM Corporation, P. O. Box 218, Yorktown Heights, NY, 10598, US

(73) Assignee: International Business Machines Corporation, Armonk, NY (US)

(21) Appl. No.: 10/303,345

(22) Filed: Nov. 22, 2002

(30) Foreign Application Priority Data
Jan. 10, 2002 (EP) 02405011.4

(51) Int. Cl. G02B 6/26

(52) U.S. Cl. 385/50; 385/39

(57) ABSTRACT

A light-coupling device comprises a body member including a light-conducting channel extending through the body member, a passage extending through the body member and intersecting the at least one channel, and a plug inter-fitting with the at least one passage. The plug has a stem with a first end and a second end. The second end of the stem has a light-reflecting face and is in a position for deflecting an optical signal and for coupling it into of from the light-conducting channel. The device can also be applied to coupling or interconnecting of light-conducting channels. For example, with a body member that includes at least one pair of light-conducting channels positioned in a parallel manner within the body member, a single passage common to both channels can be provided with a plug member at each end. A light-coupling array comprises a body member through which a plurality of light-conducting channels and a plurality of passages extend, wherein the passages intersect with at least some of the channels. It further comprises a plurality of plugs inter-fitting with the passages, wherein each plug includes a stem having a longitudinal axis and each comprising a lower end and an upper end. The upper end has a light-reflecting face intersecting with the longitudinal axis and being in a position for deflecting an optical signal and for coupling it into or out of one of the light-conducting channels adjacent the light-reflecting face.

This invention generally relates to the art of optical coupling and specifically to light-coupling devices, light-coupling arrays, a light-coupling element or plug and a method of coupling optical signals.

### TECHNICAL FIELD AND BACKGROUND OF THE INVENTION

Optical coupling systems and various elements thereof, such as optical or combined optical-electrical circuit boards and switching elements are known and disclosed, e.g. in U.S. Pat. No. 5,168,537, U.S. Pat. No. 6,059,462, and U.S. Pat. No. 6 058 228 as well as in the art of reference mentioned therein. Central elements of such coupling systems are optical boards or so-called backplanes disclosed, e.g. in WO 90/01176 or WO 00/50946.

Typically, such boards include a number of thin layers formed of a light-guiding material, such as a mineral or organic glass, with a refractive index n₂, embedded sandwich-like in a material having sufficiently differing light-guiding properties, such as an epoxy resin or another organic or inorganic embedding material, having a refractive index n₁ in the material on top of the light-guiding material, and a refractive index n₃ in the material below the light-guiding material, where n₁≠n₂≠n₃ but n₂>n₁, n₃. The material in the layer on top may be the same as that in the layer below the light-guiding layer, i.e. n₁=n₃.

Further, the light-guiding layers may have a planar form, or they may be shaped into multiple stripe-formed waveguides that can be straight or curved. Typically, the thickness dimension d of the light-guiding layers or of the adjacent layers (also termed waveguides) may be in the order of a few μm (Singlemode) but may also be 50 or 62.5 μm or more in order to match with low-cost multi-mode fiber optics.

Prior art light-coupling systems suffer from their complicated structure and a less-than-optimum coupling efficiency.

### OBJECT AND ADVANTAGES OF THE INVENTION

It is an object of the present invention to provide an improved light-coupling device with a relatively simple structure yet providing a higher degree of coupling effectiveness.

This object and further advantages that will become apparent from the following specification are achieved according to the present invention by a light-coupling device as claimed in claim 1 and comprising a body member including: at least one light-conducting channel extending through the body member; at least one passage extending through the body member and intersecting the light-conducting channel, preferably at an angle of 90°; at least one plug inter-fitting with the passage; said plug including a stem having a longitudinal axis and comprising a first end and a second end; wherein the upper end has a light-reflecting face arranged for deflecting an optical signal and for coupling it into or from the at least one light-conducting channel. The first end is also referred to as lower end. The second end is also referred to as upper end.

### DESCRIPTION OF THE DRAWINGS

Examples of the invention are depicted in the drawings and described in detail below by way of example. It is shown in

FIG. 1 a schematic and broken-away illustration of a light-coupling device having one light-conducting channel;

FIG. 2 a schematic illustration of a light-coupling device with a pair of light-conducting channels;

FIG. 3 a semi-diagrammatic view of various modifications of the reflecting surface of a plug;

FIG. 4 a schematic view of a light-coupling device with two plugs;

FIG. 5 a schematic illustration of a light-coupling device with a pair of light-conducting channels;

FIG. 6 a representation of the device shown in FIG. 4 with indicated light directions;

FIG. 7 a representation of the device shown in FIG. 5 with indicated light directions;

FIG. 8 a diagrammatic presentation of an array;

FIG. 9 a semi-diagrammatic view of a device with a first type of external coupling;

FIG. 10 a semi-diagrammatic view of a device with a second type of external coupling;

FIG. 11 a semi-diagrammatic view of a device with a third type of external coupling;

FIG. 12 a semi-diagrammatic view of a device with a fourth type of external coupling;

FIG. 13 a semi-diagrammatic view of a device with a fifth type of external coupling; and

FIG. 14 a semi-diagrammatic view of a device with a sixth type of external coupling.

All the figures are for sake of clarity not shown in real dimensions, nor are the relations between the dimensions shown in a realistic scale.

### DESCRIPTION OF PREFERRED EMBODIMENTS OF THE INVENTION

The term “light-coupling device” as used herein includes but is mot limited to a device for optical as well as for opto-electrical interconnections. Consequently, it encompasses, but is not restricted to, optical coupling means for additive and subtractive coupling, e.g. beam-splitting, as well as re-routing of optical signals by deflection.

A “body member” in a light-coupling device can be any physical structure capable of including one or more light-conducting channels which may but need not be interconnected. Typical body members may have a substantially prismatic shape, e.g. a block-shaped or plate-shaped structure such as an essentially rectangular board or plate. Shapes of and materials suitable for body members are known to those experienced in the art and will not be discussed herein in detail.

A “light-conducting channel” is enclosed by the body member and is capable of passing an optical signal. It may have the stratiform structure mentioned above or have a band-shaped or rod-shaped structure. Material and shape for such channels can be selected for any given purpose by those experienced in the art. Configurations and materials suitable for such channels are known in the art.

A “passage” in a light-coupling device can be a substantially straight hole, bore, tunnel or like opening extending through the body member and intersecting one or more of the light-conducting channels within the body member, typically at an angle of 90°. It is designed to inter-fit with a plug as specified in more detail below. In a typical device the portion of the passage that is not occupied by the plug is filled with a light-conducting and typically solid material, preferably having a refractive index equal to or approximately equal to the refractive index n₂ of the light-conducting channel.

The definition of a refractive index that is approximately equal to the value of n₂ is dependent upon the specifics (e.g. sensitivity, signal strength etc.) of a given light-coupling device. An acceptable difference between the actual value of the refractive index of the filling material and that of the light-conducting channel, i.e. n₂, should lie in the order of a few percent, e.g. 4%. It typically does not exceed 10% of the difference between n₂ and n₁ or n₃, whichever of the two is closer to n₂.

Typical angles of intersection of the passage and the light-conducting channel as well as of the reflecting face of the plug can deviate from the preferred values as long as passage of an optical signal through the passage into the channel and vice versa is ascertained.

While the invention is expected to be of main benefit for multi-mode applications, it is not excluded that with a channel thickness d in the order of 10 μm, instead of, for example, 50 μm , 62.5 μm, or more for multi-mode, and with adequate manufacturing precision a match with single-mode fiber optics can be achieved as well. Multiple stacked optical layers are possible as well as a combination with one or more electrically conducting layers of the type used in conventional printed circuit boards.

A “plug” can be described as a physical structure having a stem formed of a normally solid material that has a refractive index equal to or approaching the refractive index n₂of the channel. In that case, the light-reflecting face at the upper end of the stem may be a fully reflecting or a partially reflecting coating of the type obtained by vapor deposition of a light-reflecting material, e.g. a metal, such as gold or chrome. However, the stem can be made of a material with a refractive index n₁ or n₃, or consist of an optically opaque material and the light-reflecting face could be a polished end face of the stem.

The term “normally solid” as used herein refers to a material that is a solid at ambient temperature and pressure.

When the passage for insertion of the plug intersects the light-conducting channel at the preferred angle of 90°, the light-reflecting face will be at an angle of 45° with reference to the longitudinal axis of the stem which coincides with the longitudinal axis of the passage. Generally the angle of the light-reflecting face will be half the angle between the channel and the passage. The light-reflecting face can be planar, but other shapes or structures are possible if they are capable of redirecting the optical signal impinging on the light-reflecting end face. For example, the reflecting end face may have a lens-shaped surface or a Fresnel-lens-structure.

As will be shown in more detail below, the optical signal passing into or through a light-coupling device may impinge on the light-reflecting face either through the portion of the passage above the plug into the corresponding light-conducting channel, or from the light-conducting channel into the passage portion above the plug.

According to a preferred first embodiment, the plug comprises a position control means for determining the axial and/or radial position of the light-reflecting end face. The purpose of such means is to ascertain that the light-reflecting end face will be in a correct operating position when the plug is inserted into the passage. For example and according to a preferred embodiment, the lower end of the stem is provided with a flange which—when abutting the outer surface of the body member—will limit the axial position of the light-reflecting end face at a given position along the axis of the passage. The radial position of the light-reflecting end face is the position achieved by rotation of the stem.

Radial position control can be achieved by shaping the cross-section of both the stem and of the passage such that only one position of the stem is possible. The flange at the lower end of the stem can be shaped to fit into a corresponding recess in the body member, again allowing only one axial position of the light-reflecting end face within the passage.

As already mentioned briefly above, that portion of the passage which is not filled by the plug can be filled with a light-conducting solid material having the same refractive index as the channel, or approximately said refractive index. Preferably, such filling will be accomplished after inserting the plug, e.g. by introducing a liquefied polymer or liquid pre-polymer into the residual portion of the passage “above” the end face of the plug and solidifying or setting the material used for filling. After such solidification or setting, the surface of the filling material can be ground and/or polished or provided with an optically effective surface structure of the type mentioned above for the shape of the light-reflecting end face of the plug, i.e. a lens-shaped structure or a Fresnel-lens structure. Methods suitable for producing such modifications are known in the art.

The invention is not limited to coupling into or out of a device but can also be applied to coupling or interconnecting of light-conducting channels within one and the same light-coupling device. For example, with a body member that includes at least one pair of light-conducting channels positioned in a parallel manner within the body member, a single passage common to both channels can be provided with one plug member at each end for deflecting a signal passing through one of said parallel channels into the other. Generally, the terms “light-coupling” and “optical coupling” are used synonymously herein and, as mentioned before, include additive and subtractive modifications, e.g. beam-splitting, as well as re-routing of optical signals.

For interconnection of a light-coupling device with an external light-conducting means, the body of the device can be provided with one or more connectors which may be the same or different and which are known per se in the art of optical signal transmission.

According to a second general embodiment, a light-coupling array is provided. Such an array comprises a body member which includes a plurality of light-conducting channels extending through the body member; a plurality of passages extending through the body member and intersecting at least some of the said channels at an angle of preferably about 90°; a plurality of plugs inter-fitting with the passages, wherein each plug includes a stem having a longitudinal axis and each comprising a lower end and an upper end; and wherein the upper end of each plug has a light-reflecting face intersecting with the longitudinal axis at an angle of preferably 45° and being in a longitudinal and radial position for deflecting an optical signal and for coupling it into or out of one of the light-conducting channels adjacent the light-reflecting face.

In such an array, at least some or all plug can be connected by a common end portion to form a comb-like structure for common insertion of a plurality of plugs into a body member.

According to a further embodiment, a plug is provided for optically coupling single or multiple light beams into or out of a light-conducting channel provided in a light-coupling device; the plug is adapted to fit into a passage extending through the light-coupling device and intersecting the channel preferably at an angle of 90°; the plug includes a stem having a longitudinal axis and comprising a lower end and an upper end; the upper end has a light-reflecting face intersecting with the longitudinal axis at an angle of preferably 45°; the plug is adapted to be longitudinally and radially positioned in the passage for deflecting an optical signal and for coupling it into or out of the light-conducting channel.

According to another embodiment, an optical system comprising a light-coupling device is provided as explained above and at least one optical connector means, wherein the optical connector means is capable of establishing an optical coupling between the light-coupling device and at least one additional optical device, optical fiber or optical circuit board.

According to yet a further embodiment, it is provided a method of coupling an optical signal into or out of a light-conducting channel of an optical circuit board extending there through, the board having at least one passage intersecting the light-conducting channel, preferably at an angle of 90°; the method comprises the step of providing a plug inter-fitting with the passage; the plug includes a stem having a longitudinal axis and has a lower end and an upper end; the upper end has a light-reflecting face intersecting with the longitudinal axis, preferably at an angle of 4520 , and being in a longitudinal and radial position for deflecting the optical signal and for coupling it into or out of the light-conducting channel.

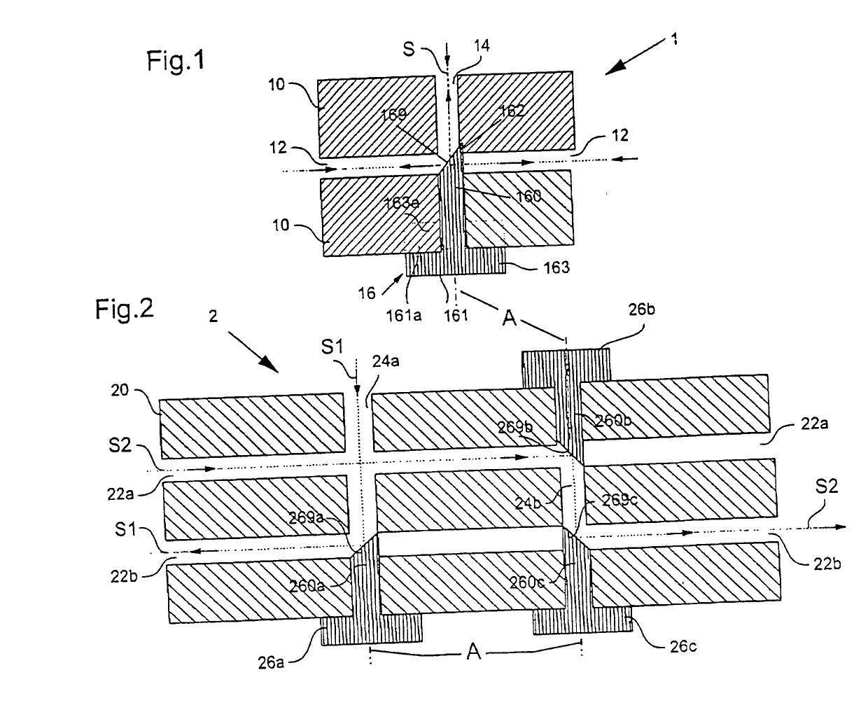

The invention will be explained in more detail by way of non-limiting examples and with reference to the attached drawings in which device 1, shown diagrammatically in FIG. 1, comprises a body 10 which has a layered structure of the type commonly used for optical circuit boards and includes at least one light-conducting channel 12 made of a light-conducting material having a refractive index n₂ which is sufficiently different from the refractive indexes n₁ and n₃ for transmission of optical signals. At least one passage 14 is provided to intersect with the channel 12, typically at an angle of 90°. A typical device or array will have a plurality of channels, and each channel may, but need not, intersect with a passage. Suitable passages may be provided by mechanical drilling or by means of a laser to provide a passage through the body 10, typically an optical circuit board. The resulting passage will be open at both ends. Production methods suitable for making such passages are known, e.g. in the art of producing electrical printed circuit boards.

Then, at least one plug 16 is inserted into the passage 14. As depicted in FIG. 1, such a plug 16 may have a substantially nail-like shape with a stem 160 and a flange 163 which could be regarded either as head or foot of stem 160. As indicated in broken lines and designated as 163a, the foot 163 could be enclosed partially or totally in a corresponding recess of the body 10. Further, such foot may have a cross-sectional shape viewed in a radial plane inter-fitting with a matching cross-sectional shape of the passage 14 which determines the radial position of the plug in the passage. Proper positioning of a plug in a passage both with regard to the radial as well as the axial position is useful because it will determine the position of the reflecting face 169 at the upper end of the plug 16. A flanged end 163 can also be used to determine the axial position or “height” of reflecting face 169 within passage 14 when it abuts with the body or a recess therein.

The plug need not have an abutting flange end nor other means suitable to determine the required axial and/or radial position of the plug since the operative position of the reflecting face 169 for coupling of an optical signal S into or out of channel 12 can well be achieved by automated assembly techniques, e.g. automated press-fitting with optical control.

When the plug 16 is in such operative position, the residual part, i.e. the portion on top of the plug 16 when viewed in FIG. 1, of passage 14 can be filled with a light-conducting material having an at least approximately matching refractive index to permit passage of optical signal S through said residual part into or out of the channel 12 and to avoid optical losses. However, such filling is a preferred but no critical feature. Suitable polymer compositions that can be introduced in liquid form and cured for solidification, such as epoxy resins, are well known in the pertinent art. The outer surface of the cured polymer fill can be machined, ground or polished and/or provided with an optically active shape, such as a lens-type shape including Fresnel-lens structures as required by the intended end-use. Such shaping can be achieved, for example, by molding or embossing. “Optically active” is meant herein to refer to means capable of modifying beam shapes.

Thus, the plug 16 has a stem 160 and a light-reflecting face 169. The stem 160 may, but need not, have a shape, e.g. an irregular octagonal cross-section, for determining the radial position of the face 169 upon insertion into the passage 14, and it can comprise either a light-conducting material with a matching refractive index for coupling into or out of passage 12, or of a material that is optically opaque or has a substantially differing refractive index.

The plug 16 has a lower end 161 which may but need not coincide with the bottom of the flange 163 and an upper end 162 with the light-reflecting face 169. Preferably, the longitudinal axis A of the stem 160 will be intersected by the face 169 at an angle of 45°.

The degree of reflection of the face 169 for coupling will depend upon the specific requirements and may by selected between fully reflecting or partially reflecting. Typical light-reflecting faces of plug can be obtained by methods such as vapor deposition of thin metallic strata or by polishing the end face of the stem 160.

Depending upon the degree of reflectivity of the face 169 and the refractive index of the stem 160, an optical signal S may pass through the channel 12 and the plug 16 in combination with coupling into or out of the channel 12 and the passage 14.

FIG. 2 shows a diagrammatic presentation of another embodiment termed “array” herein and including at least two light-conducting channels 22 (22a, 22b) within a body 20 which, in turn, can be a conventional optical circuit board as explained above in connection with FIG. 1. Again, at least one passage 24 is arranged to intersect, preferably at an angle of 9020 , with channels 22 but two passages 24a, 24b are shown in FIG. 2 for purposes of illustration.

The passage 24a is provided with a single plug 26a while the passage 24b is provided with two plugs 26b, 26c, one at each end of the passage. The channels 22a, 22b are of the same type as the channel 12 in FIG. 1 and, again, the residual part of the passages 24a, 24b is preferably filled with a curable polymer after insertion of the plugs. When two plugs 26b, 26c are used to close one passage 24b at both ends, such filling can be achieved after insertion of one plug and prior to insertion of the other and curing after insertion of the second plug. To this end, the stems of one or both of the plugs 26b, 26c may have a cross-sectional shape which includes a groove or recess so as to form a small passage which permits that excessive portions of liquid polymer used for filling of the inter-space between the plugs may escape. In other words, the term “inter-fitting” as applied to designate the relation between a plug and its associated passage does not necessarily mean a closely fitting dimensional match of the corresponding sections of plug and its associated passage.

Regarding the effect of the plugs 26, the plug 26a is analogous to the plug 16 of FIG. 1 with regard to structure, property and function, while the plugs 26b, 26c show another function and use of the invention. As is apparent from FIG. 2, two plugs 26b, 26c for closing one passage 24b at both ends can be used to deflect a signal, such as the signal S2, from one channel, e.g. the channel 22a, into another channel, e.g. the channel 22b, which may but need not be an adjacent channel. In this manner, an optical path from one optical layer into another optical layer of a circuit board can be achieved.

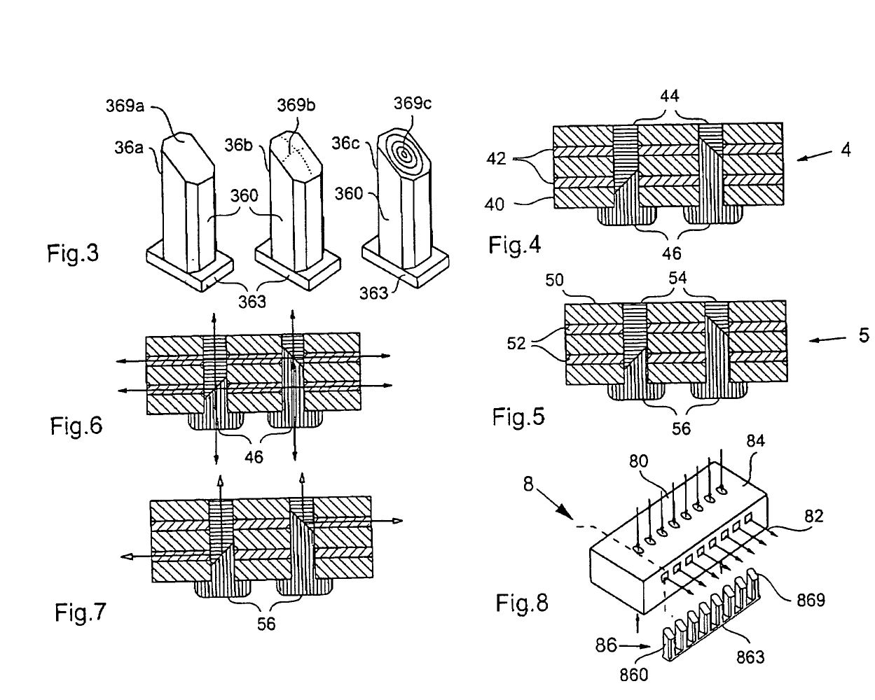

FIG. 3 is a semi-diagrammatic perspective view of modified plugs 36, all having the same type of flange end 363 and the same stem 360 with an octagonal cross-section for determining the axial and longitudinal position of the light-reflecting face 369 which may be a plain metallic or metallized surface 369a, or have a lens-shape 369b, or be structured as a Fresnel-type lens 369c. Such structures can be manufactured in various ways including injection molding or embossing.

FIG. 4 is another diagrammatic presentation of a device 4 with light-conducting channels 42, passages 44, and plugs 46. The refractive index of the material of the plugs 46 is substantially the same as that of the channels 42 and of an optional filling of those parts of the passages 44 that are not occupied by the plugs 46. This permits signal passage if the reflecting plug faces are semi-reflecting.

FIG. 4 serves to show the structure while FIG. 6 illustrates function, namely transmission in all directions indicated by the arrows of device 4.

FIG. 5 is a further diagrammatic presentation of a device 5 in which the plugs 56 in the passages 54 are optically opaque or have a substantially different index of refraction from that of the channels 52 and any solid filling in the passages 54. As a consequence and as shown in FIG. 7, transmission of optical signals is limited to those indicated by the arrows. FIG. 7 shows the function of the device 5 shown in FIG. 5.

FIG. 8 illustrates an array 8 with a plurality of channels 82 in the body 80 with the passages 84 and an aggregate 86 formed of a plurality of plug stems 860 and a common flange or connector 863 in such manner that all plugs can be inserted into the body 80 by a single operation. While the length of the stems 860 is shown as equal so as to form a comb-like structure, this is not a necessary condition and stems of different length could be connected by a common flange end. The spacing of the stems can be chosen, for example, in the order of from about 50 μm to about 250 μm in order to match with the common pitch of fiber ribbons or active array-type devices.

If a vertical incidence of light beams to be coupled into a light-coupling device or optical board is not feasible, a horizontal emitter, such as an edge-emitting laser can be used. In such cases, an additional reflection step can be implemented in a manner similar to that which can be achieved by means of a plug.

Generally, it is desirable to attempt matching the diameters of all optical paths involved in order to minimize optical losses in both directions. If matching diameters would be too costly, the width of the plug stems can be increased. Optical losses resulting, for example, from coupling a thicker plug stem into a thinner fiber core can be eliminated or reduced by beam shaping means as mentioned above, i.e. lens-shaped ends or Fresnel-type lens ends.

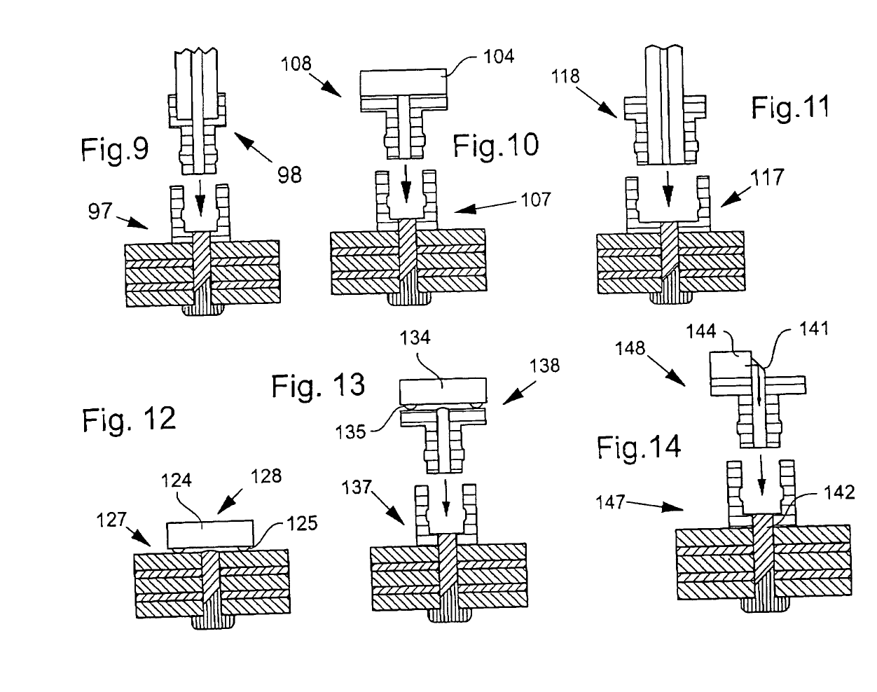

As shown in FIGS. 9-14, devices enumerated schematically with the numbers 97, 107, 117, 127, 137, and 147 provide for coupling with various types of optical fiber connectors, optical devices or other optical boards by butt-coupling at the unplugged ends of the passages of coupling devices or arrays. Various non-limiting types of interconnections are illustrated schematically in FIGS. 9-14 to show both removable (i.e. pluggable) or permanent interconnections.

FIG. 9 illustrates an example of a pluggable optical fiber connection which could be part of a single-fiber or fiber ribbon connection (MT-type connector). A male connector part 98 of a connectorized optical fiber according to any desired optical connector standard can be plugged into a matching female connector part 97 that is mounted on top of a fiber-coupling device in such a way that optical coupling occurs between the fiber and the filled passage of the fiber-coupling device underneath when the male connector part 98 is latched into the female connector part 97.

FIG. 10 illustrates an example of a pluggable optical device 104 including, for example, a VCSEL (Vertical Cavity Surface Emitting Laser). A male connector part 108 of the pluggable optical device 104 according to any desired optical connector standard can be plugged into a matched female socket 107 that is mounted on top of a fiber-coupling device in such a way that optical coupling occurs between the waveguide inside the male connector part 108 and the filled passage of the fiber-coupling device underneath when the connectorized pluggable optical device 104 is latched into the female socket 107.

FIG. 11 illustrates a pluggable solution for an optical board-to-backplane connection. The male connector part 118 of the connectorized edge of an optical board can be plugged into a matched female connector part 117 that is mounted on top of a coupling device in an optical backplane in such a way that optical coupling occurs between the waveguide inside the pluggable optical board and the filled passage of the coupling device underneath when the optical board is latched into the female connector part 117 on the optical backplane.

Coupling surfaces on the face of the body member or board, or on the face between the female part and the male part of the connectors depicted in FIGS. 9-11 could be either flat so that conventional butt-coupling can be applied or they could be lens-shaped or might have a Fresnel-lens structure embossed as mentioned above so that efficient coupling through an air gap can be achieved. In the case of butt-coupling, the filled passage of the coupling device extends into the female connector part so that its upper surface can face directly the fiber or waveguide endface of the plugged-in component.

Further examples of non-pluggable and pluggable combinations of light-coupling devices are shown in FIGS. 12 and 13 where a VCSEL, or another light source or light receiver 124, 134 is connected with a light-coupling device 127, 137. Such connection may either be a permanent (i.e. not releasably pluggable) connection as in FIG. 12 where the physical connection of the VCSEL 124 with an optical circuit board is achieved by soldered pins 125 or similar means for permanent connection. The end of the passage of the light-coupling device 127 in FIG. 12 and similarly of the male connector part 138 in FIG. 13 is here lens-shaped as explained above. Alternatively, as shown in FIG. 13 and FIG. 14, a VCSEL or another light source or receiver 134, 144 may be part of a pluggable connection, whereas FIG. 13 shows a pluggable variant that combines the concepts shown in FIG. 10 and FIG. 12 while FIG. 14 shows a variant where a horizontally emitting light source or receiver 144 is mounted on a pluggable connector 148 including a deflecting light-conductor 141.

While various embodiments of the invention have been explained in some detail above on the basis of specific examples it is to be emphasized that such examples are not intended to limit the invention.

1. A light-coupling device comprising
a body member,
at least one light-conducting channel extending therethrough
at least one passage extending through said body member and intersecting said channel;
further comprising at least one plug inter-fitting with said at least one passage; said plug comprising a stem having a first end and a second end; wherein said second end has a light-reflecting face for deflecting an optical signal in said at least one light-conducting channel.

2. The light-coupling device according to claim 1, wherein said stem has a longitudinal axis and wherein said passage intersects with said at least one channel at a first angle, and wherein said light-reflecting face intersects with said longitudinal axis at a second angle that is substantially half the first angle.

3. The light-coupling device according to claim 1, wherein said plug comprises a position control means for determining one of the axial and radial position of said light-reflecting face.

4. The light-coupling device according to claim 3, wherein said position control means comprises a flange at said first end of said stem.

5. The light-coupling device according to claim 1, wherein said light-reflecting face comprises a metallic surface.

6. The light-coupling device according to claim 1, wherein at least said stem of said plug comprises an optically transparent material, and wherein at said light-reflecting face a coating layer is disposed, comprising at least partially reflective material.

7. The light-coupling device according to claim 1, wherein said light-reflecting face comprises an optically effective surface structure for controlling the optical signal impinging thereon.

8. The light-coupling device according to claim 7, wherein said surface structure comprises one of a lens-shaped structure and a Fresnel-lens structure.

9. The light-coupling device according to claim 1, wherein a first portion of said passage is filled with said plug while a second portion part of said passage is filled with a light-conducting material, preferably having a refractive index being substantially equal to the refractive index of said at least one light-conducting channel.

10. The light-coupling device according to claim 9, wherein said light-conducting material in said passage has an outer end face that is substantially co-planar with an outer surface of said body member; said end face having an optically effective surface structure, preferably one of a lens-shaped structure and a Fresnel-lens structure.

11. The light-coupling device according to claim 1, wherein said body member includes at least one pair of substantially parallel light-conducting channels being intersected by said passage being a common passage and having a said plug at each end thereof.

12. A light-coupling device according to claim 1, wherein said body member is provided with at least one external connector means for connecting an external optical conductor with at least one end of said at least one passage.

13. A light-coupling array comprising
a body member including a plurality of light-conducting channels extending through said body member and
a plurality of passages extending through said body member and intersecting at least some of the said channels;
further comprising a plurality of plugs inter-fitting with said passages; each of said plugs having a longitudinal axis and a first end and a second end; wherein said second end has a light-reflecting face intersecting with said longitudinal axis and is arranged in a position for deflecting an optical signal in one of said light-conducting channels adjacent said light-reflecting face.

14. The light-coupling array according to claim 13, wherein several of said plugs are connected by a common end portion for common insertion into said body member.

15. A plug for optically coupling at least one light beam in a light-conducting channel in a light-coupling device; said plug being adapted to fit into a passage extending through said light-coupling device and intersecting said channel; said plug comprising a stem having a longitudinal axis and a first end and a second end; wherein said second end has a light-reflecting face intersecting with said longitudinal axis and wherein said plug is adapted for positioning said light-reflecting face in said passage for deflecting an optical signal in said light-conducting channel.

16. An optical system comprising
a light-coupling device according to claim 1, and
at least one optical connector for establishing an optical coupling between said light-coupling device and a device selected from the group consisting of at least one of an additional optical device, optical fiber or optical circuit board.

17. A method for coupling an optical signal in a light-conducting channel of an optical circuit board that has at least one passage extending therethrough and intersecting said channel; said method comprising the step of arranging at said optical circuit board a plug inter-fitting with said passage and having a longitudinal axis and a first end and a second end that has a light-reflecting face intersecting with said longitudinal axis and being in a position for deflecting said optical signal in said light-conducting channel.
